(19) United States
(12) Patent Application Publication
(10) Pub. No.: US 2010/0175717 A1
(43) Pub. Date: Jul. 15, 2010

(54) METHOD AND APPARATUS FOR CLEANING THE CYLINDERS OF PRINTING MACHINES OF THE CONTINUOUS TYPE

(76) Inventors: Marco Corti, Province of Bergamo (IT); Riccardo Fumagalli, Province of Lecco (IT)

Correspondence Address: STITES & HARBISON PLLC, 1199 NORTH FAIRFAX STREET, SUITE 900, ALEXANDRIA, VA, 22314, US

(21) Appl. No.: 12/522,073

(22) PCT Filed: Dec. 28, 2007
(86) PCT No.: PCT/IB07/55328

§ 371 Date: Feb. 25, 2010

(30) Foreign Application Priority Data
Jan. 5, 2007 (IT) BO2007A000004

(51) Int. Cl. B08B 7/00

(52) U.S. Cl. 134/6; 134/198

(57) ABSTRACT

The method for cleaning the cylinders (C1-C1′, C2-C2′, C3-C3′, C4-C4′) of printing machines of the continuous type comprises a primary delivery stage which provides for delivering most or all of the solvent-containing cleaning fluid required for cleaning the printing machine's cylinders, that can be safely carried by the web (N) even in the subsequent drying stage, to one or both of the opposite surfaces of the paper web, upstream of the entire set of printing cylinders, by spraying or by any other controlled variable delivery technique, while the previously mentioned units (P) cleaning the sets of printing rollers have, in addition to the task of mechanical action, also been given the task of secondary delivery of the remaining quantity of the said solvent-containing cleaning fluid or a cleaning fluid containing little or even no solvent and proportionately rich in water, all so that the quantity of cleaning fluid delivered during the secondary stage by the cleaning units (P) equipping the printing cylinders is at least sufficient to keep the surfaces of the cylinders which are not in contact with the paper web.

The invention relates to a method and apparatus of the combined type for cleaning the cylinders of printing machines of the continuous type, for example of the so-called reel type, fitted with rubber printing cylinders which act simultaneously on the opposite surfaces of a continuous paper web unwound from the reel.

In order to carry out cyclical cleaning of the cylinders of these machines, work is currently done on individual cylinders using equipment of various kinds which comes into overall contact with the surface of the said cylinders, for example a cloth or other means soaked in a cleaning fluid generally comprising a suitable mixture of water and solvent which can remove part of the dirt dissolved by the fluid and/or which ensures that the dirt or its residue is carried onto the paper web which is kept in continuous movement at the right speed together with the cylinders being cleaned, and which subsequently transmits part of the cleaning fluid discharged from the sets of cylinders upstream to the said cylinders.

FIG. 1 illustrates the conventional and simplified system of a succession of four sets of printing cylinders, indicated by C1, C2, C3, C4 and C1′, C2′, C3′, C4′ which are respectively associated with cleaning units P1, P2, P3, P4 and P1′, P2′, P3′, P4′ of the aforesaid type, while N indicates the paper web which advances in the direction indicated by F. If each cleaning unit delivers for example 10 ml of fluid per second, the length of paper N between the first and second set of cylinders C1, C1′ and C2, C2′ discharges the first 10 ml of fluid onto the opposite surfaces, the length of paper between the second and third sets of cylinders C2, C2′ and C3, C3′ discharges 20 ml of fluid, the length of paper between the third and fourth sets of cylinders C3, C3′ and C4, C4′ discharges 30 ml of fluid, and finally from the last set of cylinders the paper web discharges onto opposite surfaces the sum of the said deliveries from the individual cleaning units, totalling 40 ml of fluid. It is obvious from this arrangement that the distribution of cleaning fluid is only advantageous for the last set of cylinders which are affected by the fluid delivered by the corresponding cleaning units and that carried by paper web N. It is further obvious that, as a consequence of such irregular distribution of the fluid over the printing cylinders, the times for a full cleaning cycle for the machine are governed by the cylinders upstream, which receive less fluid than the others. On the other hand the quantity of cleaning fluid delivered by the individual units cannot exceed the limits imposed by the capacity for safe disposal of a portion of the solvent by the drying stove located downstream from the sets of printing cylinders, and increasing the quantity of solvent distributed on the first set of cylinders C1, C1′ also cannot be envisaged as these would be prejudiced in that an excessive quantity of solvent would give rise to uncontrolled distribution of the dirt over the entire surface of these cylinders, because the said cylinder cleaning units are usually dimensioned to operate over the maximum working width of the printing cylinders. This method of operation would contaminate the printing machine and would unacceptably increase the times for the machine to return to quality after a washing cycle.

In addition to the said disadvantages there is the fact that if the cylinders work on a paper web of minimum width, the said cleaning units will deliver the cleaning fluid to both the central working part of the cylinders, that which is working on the paper web, and the non-working sides of the cylinders. This condition will give rise to the use of very large quantities of solvent, which will be partly dispersed in the air and partly recovered by specific cleaning means, with corresponding costs and corresponding cycle times. This recovery is however never total, as a result of which some of the cleaning fluid remains on the unused side parts of the printing cylinder, causing a considerable delay in the time for the printing machine to return to quality, or the times required for the machine to clean itself and to return to producing prints of acceptable and constant quality.

The known art teaches the use of cleaning fluids of the oily type, which are also ecological in that they are vegetable-based, with an evaporation factor which is half that of conventional mixtures of fluids characterised by a low water content and therefore by the ability to be used in quantities which are for example twice those of conventional fluids, without prejudicing the tensile strength of the paper web. Tests have been carried out on the use of these fluids in the cloth cleaning systems mentioned above in order to reduce the cycle times for cleaning printing cylinders, but instead of shortening cycle times the times and costs of returning the printing machine to quality have been increased and this disadvantage has stood in the way of the use of these oil-based cleaning fluids.

When faced with very stubborn dirt, those responsible for the operation of printing machines of the rotary type sometimes spread solvent-containing cleaning fluid, in bottles which are tipped over and caused to oscillate transversely over the web, onto the paper web as it advances, upstream from the printing cylinders, so that the spread solvent affects the full width of the web, but with a distribution which is certainly not uniform. This operation is carried out in the justified conviction that when the paper web is partly soaked with solvent it comes into contact with the active surface of the printing cylinders, with the ability to improve the operation of cleaning these cylinders, assisting the action of the cloth or other type of cleaning equipment with which the cylinders are equipped. In recent times equipment with irrigating bars located transversely over the paper web upstream of the printing cylinders has also been proposed in order to uniformly distribute small quantities of solvent over the web so as to carry out in an automatic and improved way what was previously carried out manually by those responsible for operating printing machines. The use of such equipment has not however succeeded in substantially reducing the times and quality of printing machine cylinder wash cycles.

The known art also teaches the use of means to deliver oily solvent to only one side of the paper web before it reaches the printing cylinders, as described in patent application WO-2005/108087, brush cleaning means being provided on these cylinders with corresponding solvent delivery bars. This arrangement has not however solved all known problems, in that it can be used only with particularly absorbent paper webs and therefore does not ensure secure control of the quantity of solvent placed in circulation by the entire system, which can in fact give rise to safety problems in the subsequent stages of drying the web which is soiled with ink and solvent.

The object of the invention is to overcome these limitations of the known art with a method and apparatus according to claim 1) and subsequent dependent claims based on the following concept. The solvent used is preferably of the abovementioned oily type and almost all or all of the solvent required for cleaning the printing machine cylinders is delivered to one or both opposite surfaces of the paper web in a controlled and distributed way by a primary unit, located upstream from the set of printing cylinders, which delivers solvent by spraying a quantity proportional to the speed of advance of the paper web and is equipped with means for immediate recovery of the solvent delivered by such units to the sides of the same paper web in order to prevent such surplus fluid from soiling the printing machine. The said cleaning units with which the individual printing cylinder sets are provided are caused to deliver very limited quantities of the said solvent-containing cleaning fluid, or quantities which have little or no solvent and much water, at least sufficient to keep the non-working surface of the cylinders lubricated and clean. As the cleaning fluid delivered by these units with which the printing machine cylinders are equipped contains a high percentage of water, it ensures such lubrication and improves the removal of paper particles and fibres from the cylinders.

Further features of the invention and the advantages deriving therefrom will be more apparent from the following description of a preferred embodiment of the same, illustrated purely by way of a non-limiting example in the figures of the two appended plates of drawings in which, in addition to FIG. 1 already considered, it will be seen that:

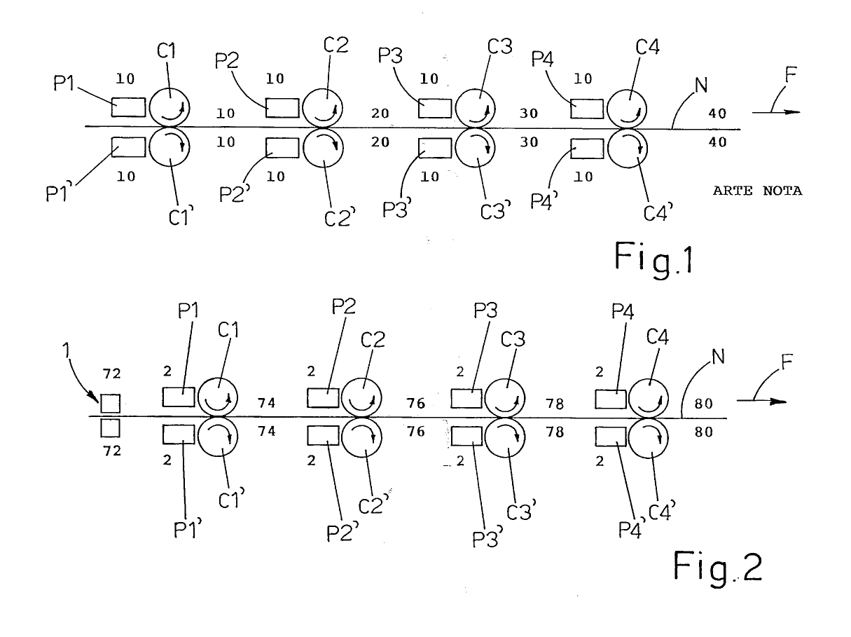

FIG. 2 is a diagrammatical view of a cleaning method and apparatus of a composite type according to the invention,

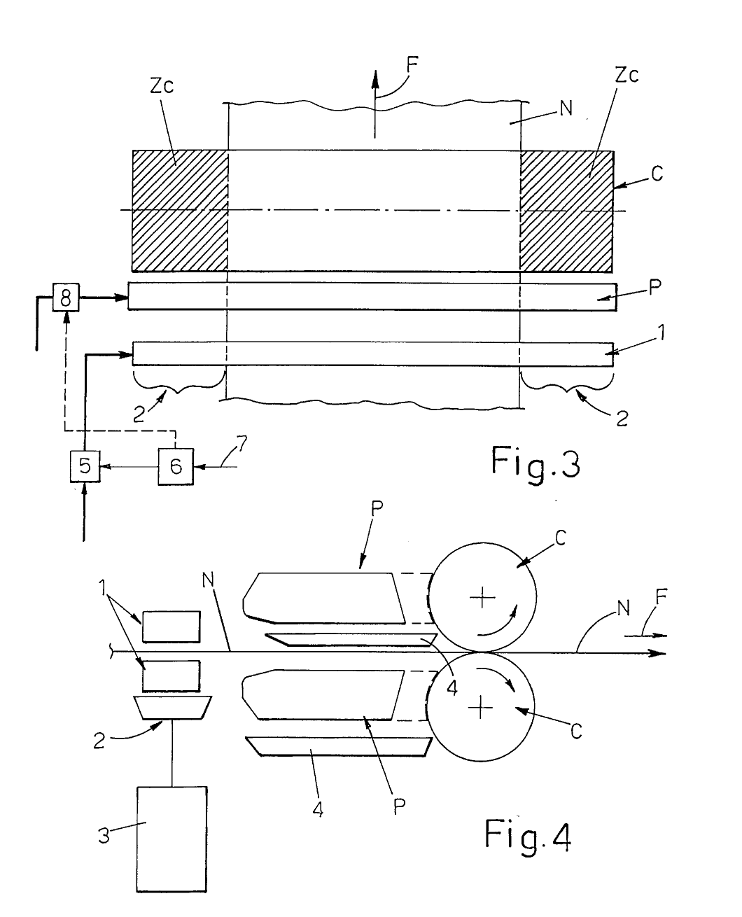

FIG. 3 is a diagrammatical view in plan from above of the paper web passing over the primary units for delivery of the solvent-containing cleaning fluid which subsequently passes over the printing cylinder with the corresponding cleaning unit,

FIG. 4 is a diagrammatical side view of the same set of means illustrated in FIG. 3.

In the method according to the invention cleaning fluids containing solvent of the oily type, as previously mentioned, characterised by a solvent evaporation factor which is substantially half that of conventional water and solvent mixtures, and which can therefore be used in double the quantity and which are marked by a very low water content so as not to adversely affect the tensile strength characteristics of the paper web inserted into the printing machine can advantageously be used. FIG. 2 illustrates the same simplified diagram of printing cylinders and cleaning devices as in FIG. 1, with the difference that on leaving the last set of printing cylinders before the drying stove, paper web N carries not more than 40 ml of solvent fluid on its opposite surfaces, as in the example in the known art in FIG. 1, but twice the quantity, for example 80 ml of solvent-containing cleaning fluid of the oily type, so as to set up the system for substantially halving printing machine cleaning cycle times.

According to the invention a large quantity of the said solvent-containing cleaning fluid, or all that fluid, is delivered directly to at least one or both opposite surfaces of paper web N from a primary unit 1 located immediately upstream of the entire train of printing cylinders. This primary unit delivers a quantity of the said solvent-containing cleaning fluid, for example of the order of approximately 72 ml per second, by spraying to the surface or surfaces of paper web N, while the remaining quantity of solvent-containing fluid (80−72=8 ml) is subdivided between the various cleaning units P1, P2, P3, P4, P1′, P2′, P3′, P4′, each of which will deliver 2 ml of fluid per second. A very high percentage of the solvent-containing cleaning fluid, of the order of approximately 80-90%, is then transported from the paper web passing through the printing cylinders in succession, the cleaning units P of which, of the cloth or other type, use this fluid originating from the paper web and also themselves deliver a quantity of solvent-containing fluid of the order of 10-20%, at least sufficient to keep the inactive side parts of the printing cylinders lubricated and clean. The fluid delivered by the cloth cleaning units with which the printing cylinders are equipped contains the same type of fluid containing oily solvent delivered by the said primary unit and may contain a very high percentage of water which satisfactorily performs the lubricating task and ensures better removal of paper particles and fibres, above all when web N comprises recycled paper which has a tendency to turn to dust. This aqueous component, acting together with friction with the printing cylinder, tends to dry quickly and the small quantity which may reach the paper web finds that the latter is already impregnated with oily solvent and therefore in a substantially impermeable condition. It remains understood that during the printing machine wash cycle, provision may be made for cleaning units P to be inactive at some stages or to act to reduce or even remove solvent and deliver only water, and primary unit 1 may be responsible for the delivery of correspondingly more of or all the solvent which can be safely carried to the drying stove by the paper web. The abovementioned percentage deliveries of solvent-containing cleaning fluid should therefore be understood to be protected within the range between 100-80% for primary unit 1 and the remaining 0-20% for all cleaning units P.

FIGS. 3 and 4 show that primary unit 1 is arranged laterally so as to work with paper webs of the maximum width which can be used in the printing machine and is equipped with means 2 for recovering the quantity of fluid which that unit delivers laterally to paper web N and return it directly to a recovery tank 3 with corresponding filter means, above all when the paper web is of a width less than the maximum which can be used in the printing machine, as a result of which area ZC of printing cylinder C at the sides of paper web N will only be reached by a small quantity of solvent-containing cleaning fluid, for example of the order of approximately 2 ml/sec, delivered by cleaning unit P with which the cylinder is equipped, sufficient to keep the contact between the cloth of cleaning unit P and the inactive surfaces ZC of the printing cylinder lubricated and clean. FIG. 4 shows that as a result of the small quantities of solvent-containing cleaning fluid delivered to the said parts ZC of the printing cylinders it is no longer necessary to provide means and cycle times for cleaning these parts of the cylinders at the end of the cleaning cycle, the provision of small safety containers 4 beneath each individual cleaning unit P being sufficient for this, without having to connect these to recovery circuits.

Now considering FIG. 2, it will be seen that first set of cylinders C1, C1′ will for example be provided with 74 ml of solvent-containing fluid (72 ml delivered by primary unit 1, together with 2 ml delivered from cleaning units P1 or P1′); the second set of cylinders C2, C2′ will receive 76 ml of solvent-containing fluid; the third set of cylinders C3, C3′ will receive 78 ml of solvent-containing fluid and the fourth set of cylinders C4, C4′ will receive 80 ml of solvent-containing fluid. It is obvious that the new arrangement comprises a balanced and uniform distribution of cleaning fluid to the printing cylinders (increasing from 74 ml for the first set to 80 ml for the last set), with the advantages of a cleaning cycle length which is substantially half that in the known art, with the advantage of substantially halving the print copies of unacceptable quality produced by the printing machine during the stage of self-cleaning after each wash cycle which have to be discarded, substantially halving the cost of the entire wash cycle in comparison with a cycle of the known art.

Primary unit 1 comprises means 5 for the delivery of solvent-containing cleaning fluid to the spray bar or bars controlled by a processing unit 6, to input 7 of which is provided a signal relating to the speed of advance of the paper web so as to ensure that the quantity of fluid delivered to the opposite surfaces of paper web N in said primary unit 1 is automatically adjusted in a way which is directly proportional to the speed of advance of paper web N without exceeding the maximum limits guaranteeing safe functioning of the drying stove which paper web N will pass through after working together with the various printing rollers. An operating and logical connection between processing unit 6 and generic means 8 which control the feed of fluid to cleaning units P of the printing cylinders may advantageously be provided for this purpose to ensure that if the quantity of solvent-containing fluid delivered by primary unit 1 increases or decreases the quantity of fluid with solvent delivered by the complex of cleaning units P will decrease or increase to prevent exceeding the maximum quantity of solvent which the paper web discharges with the dirt, after contact with primary unit 1 and then in working together with the printing cylinders, and carries into the drying stove. It remains understood that the circuit diagram in FIG. 3 is purely in the form of an example which can be constructed otherwise, including using wireless technology.

It remains understood that the method and equipment described are to be regarded as being protected even in printing machines in which the paper web moves forward vertically instead of horizontally as illustrated in the drawings, and in which primary unit 1 comprises bars for the delivery of cleaning fluid to only one surface of the paper web.

Primary unit 1 with corresponding lateral recovery means 2 has not been illustrated here in the construction details in that it may also be of a known type

1. Method for cleaning the cylinders of printing machines of the continuous type, for example of the so-called reel type, fitted with sets of printing cylinders (C1-C1′, C2-C2′, C3-C3′, C4-C4′) which act simultaneously on the opposite surfaces of the continuous paper web (N) unwound from the reel, in which each cylinder is equipped with corresponding direct cleaning means (P1-P1′, P2-P2′, P3-P3′, P4-P4′) of any suitable type capable of delivering a quantity of cleaning fluid containing solvent for ink to that cylinder, which can remove part of the dirt dissolved by the fluid and/or which ensures that the dirt or its residue is carried onto the paper web (N) which is kept in continuous movement at the appropriate speed and in contact with the cylinders undergoing cleaning and which subsequently transmits upstream to the said cylinders part of the cleaning fluid discharged from the sets of cylinders, a method characterised by combined stages of delivery of the solvent-containing cleaning fluid and in particular a primary delivery stage which provides for delivering most or all of the solvent-containing cleaning fluid required for cleaning the printing machine's cylinders, that can be safely carried by the web even in the subsequent drying stage, to one or both of the opposite surfaces of the paper web, upstream of the entire set of printing cylinders, by spraying or by any other controlled variable delivery technique, while the previously mentioned units (P) cleaning the sets of printing rollers have, in addition to the task of mechanical action, also been given the task of secondary delivery of the remaining quantity of the said solvent-containing cleaning fluid or a cleaning fluid containing little or even no solvent and proportionately rich in water, all so that the quantity of cleaning fluid delivered during the secondary stage by the cleaning units (P) equipping the printing cylinders is at least sufficient to keep the surfaces of the cylinders which are not in contact with the paper web, and which are not working, lubricated and clean, so that if the cloth or brush parts of the said cleaning units brush against this surface there is no damage to the surfaces which work together with sliding friction.

2. Method according to claim 1) in which the quantity of solvent-containing cleaning fluid delivered directly to one or the opposite faces of the paper web (N) during the primary stage lies for example within the range of 80-100% of the total quantity of solvent-containing fluid which the said web can carry with it during the drying stage to ensure safe operation of this stage, while the remaining quantity of the said solvent-containing cleaning fluid, in the range 0-20%, is entirely delivered to the sets of printing rollers by the corresponding cleaning devices with which they are equipped, subdivided by the number of such devices, to lubricate and clean the area of the cylinders which is not covered by paper so as not to contaminate the printing machine.

3. Method according to claim 1), characterised by the use of cleaning fluids containing solvent of an oily type with a limited evaporation factor for the solvents contained in them, for example with such a factor being equal to approximately half that of present mixtures of solvent and water, without contaminating the printing machine so that for example double quantities of the said oily fluids in comparison with the quantities of present mixtures can be used to substantially halve the times for the current cycles of washing and cleaning printing rollers.

4. Method according to claim 1), in which the cleaning fluid delivered by the cleaning units with which the printing cylinders are equipped may contain the same quantity of fluid with oily solvent delivered to the paper web during the said primary stage and/or a compatible fluid mixed with a high percentage of water which satisfactorily performs the task of lubrication and which ensures better removal of paper particles and fibres from the said cylinders.

5. Method according to claim 1), in which the cleaning fluid is distributed by spraying in the said primary stage and in relation to the greatest width of paper which can be inserted into the printing machine and in which provision is made for a stage of immediate recovery of the fluid delivered laterally to the paper web, above all if this web is of a width less than the maximum which can be inserted into the printing machine.

6. Method according to claim 1), in which the solvent-containing cleaning fluid is delivered to the paper web in the said primary stage, in quantities which vary in relation to the speed of advance of the web.

7. Equipment for cleaning cylinders in printing machines of the continuous type, particularly for implementation of the method according to any one of the preceding claims, characterised in that it comprises at least one primary unit (1) operating immediately upstream of the train of sets of rollers in the printing machine and which provides and delivers most or all of the solvent-containing cleaning fluid required for cleaning the cylinders to at least one or both opposite surfaces of the paper web (N) advancing at the correct speed and in contact with the cylinders, by spraying and/or by other suitable equivalent means, the primary unit (1) being equipped with means (2) for immediate recovery of fluid delivered laterally to the paper web, particularly if it is of a width less than the maximum, and being provided with means to ensure that the cleaning units (P) of the printing cylinders deliver a quantity of cleaning fluid containing a very small amount of or even no solvent, rich in water.

8. Equipment according to claim 7) characterised in that the said primary unit (1) comprises means (5) for the delivery of solvent-containing cleaning fluid controlled by a processing unit (6), to one input (7) of which arrives a signal related to the speed of advance of the paper web to ensure that the quantity of fluid delivered to the opposite surfaces of the paper web (N) by the said primary unit (1) is automatically adjusted in a manner directly proportional to the speed of advance of the said paper web (N) without exceeding the maximum limits which ensure safe operation of the drying stove which the paper web (N) passes through after working together with the various printing cylinders.

9. Equipment according to claim 8), characterised in that it comprises a logical operating connection between the said processing unit (6) and the means (8) controlling the delivery of fluid to the cleaning units (P) of the printing cylinders so that the quantity of solvent-containing fluid delivered by the primary unit (1) increases or decreases as the quantity of the said solvent-containing fluid entering the complex of cleaning units (P) decreases or increases in order to avoid exceeding the maximum quantity of solvent which the paper web (N) discharges with the dirt and introduces into the drying stove after contact with the primary unit (1) and after acting together with the printing cylinders (C).
